(19) United States
(12) Patent Application Publication
(10) Pub. No.: US 2015/0026713 A1
(43) Pub. Date: Jan. 22, 2015

(54) METHOD AND SYSTEM FOR IN-FLIGHT HANDLING OF PERSONALIZED ENTERTAINMENT DATA

(71) Applicants: Lakshya Jain, Los Altos, CA (US); Priya Jain, Los Altos, CA (US)

(72) Inventors: Lakshya Jain, Los Altos, CA (US); Priya Jain, Los Altos, CA (US)

(21) Appl. No.: 14/328,732

(22) Filed: Jul. 11, 2014

(51) Int. Cl. H04N 21/414; H04N 21/433; H04N 21/258; H04N 21/475; H04N 21/214; H04N 21/441

(52) U.S. Cl. CPC H04N 21/41422; H04N 21/2146; H04N 21/441; H04N 21/25875; H04N 21/4753; H04N 21/433
USPC 725/23; 725/76

(57) ABSTRACT

The present disclosure provides a method and system for in-flight handling of personalized entertainment data. The method and system stores a plurality of digital content of each of one or more digital entertainment systems associated with each of one or more aerial vehicles, associates an identifier with each of one or more users for accessing the one or more digital entertainment systems and saves a plurality of attributes associated with each of the identifier with each of the one or more users and access the one or more digital content from a first set of each of the one or more aerial vehicles pertaining to the digital entertainment systems associated with each of the identifier.

### TECHNICAL FIELD

The present invention relates to the field of in-flight personalized user data and, in particular, relates to handling of the in-flight personalized user entertainment data.

### BACKGROUND

In the past few years, entertainment industry has witnessed an enormous growth. Moreover, combination of technology with the entertainment industry has led to availability of the entertainment options anywhere and at anytime. In-flight entertainment (IFE) is one of the most interesting entertainment options available to flight passengers. The in-flight entertainment refers to the entertainment available during the flight to passengers in an aircraft. The in-flight entertainment includes audio entertainment, video entertainment, in-flight movies, in-flight games, personal televisions and the like. The in-flight entertainment can be provided using various equipments including personalized televisions, digital gaming devices and the like. Generally, the in-flight entertainment equipments are touch sensitive and wireless, allowing interaction between the passengers in the aircraft and flight attendants. Moreover, many people have been benefited due to utilization of the technology in the field of the entertainment. For example, closed captioning technology for deaf and hard-of-hearing passengers; moving map system for monitoring position and direction of the aircraft; a system for monitoring altitude, airspeed, temperature and the like.

Moreover, the combination of technology with the entertainment industry has led to provision of the in-flight connectivity services. Examples of the in-flight connectivity services include but may not be limited to Internet browsing, text messaging, cell phone usage, electronic mail and the like.

Moreover, due to technological advancement, some airlines install personal televisions (hereinafter PTVs) corresponding to each of the passengers in the aircraft to provide the entertainment facility. The PTVs may be located in seat-backs or may be tucked in armrests of front row seats. Moreover, the PTVs may offer variety of services to the passengers including live TV broadcasts, video games, internet surfing and the like. However, as soon as the passengers de-board the aircraft, their personalized entertainment data is removed from the PTVs.

Currently, no in-flight entertainment systems are available that enable the passengers to control the personalized entertainment data. For example, a passenger has boarded the aircraft for a long distance journey involving changing of the aircraft at one or more intermediate terminals. Moreover, the passenger is playing a game while travelling in the first aircraft. The passenger has crossed various levels in the game and earned credits from the game. However, the terminal arrives and the passenger has to change the aircraft. It may be noted that the entertainment device is installed in the aircraft; thus, the passenger has to leave the game in the intermediate. However, no system is available that enables the passengers to resume their personalized entertainment data after de-boarding of the first aircraft.

In light of the above stated discussion, there is a need for a method and system that overcomes the above stated disadvantages and facilitates the in-flight personalization of passenger's entertainment data. Moreover, the method and system should enable the passengers to resume the entertainment activities performed in the aircraft. Further, the method and system should enable the passengers to use the personalized entertainment data in the aircraft as well as outside the aircraft.

### SUMMARY

In an aspect of the present disclosure, a method and system for in-flight handling of personalized entertainment data is provided. The method and system include storing a plurality of digital content of each of one or more digital entertainment systems associated with each of one or more aerial vehicles, associating an identifier with each of one or more users for accessing the one or more digital entertainment systems, saving a plurality of attributes associated with each of the identifier with each of the one or more users and accessing one or more digital content from a first set of each of the one or more aerial vehicles pertaining to the digital entertainment systems associated with each of the identifier.

In an embodiment of the present disclosure, the method and system include the plurality of attributes associated with the one or more digital content.

In another embodiment of the present disclosure, the method and system include the plurality of attributes of the one or more users.

In yet another embodiment of the present disclosure, the identifier is an alphanumeric code.

In yet another embodiment of the present disclosure, the method and system include enabling each of the one or more users to input the identifier.

In yet another embodiment of the present disclosure, the method and system include the module to provide credit points associated with accessing the plurality of digital content.

In yet another embodiment of the present disclosure, the method and system include an enabling module to enable each of the one or more users to redeem the credit points when a pre-determined amount of the credit points associated with the at least one or more users exceeds a pre-defined point.

In another aspect of the present disclosure, the method and system include a storing module to store the plurality of digital content of each of the one or more digital entertainment systems associated with each of the one or more aerial vehicles, an enabling module to enable association of the identifier with each of the one or more users for accessing the one or more digital entertainment systems, a saving module to save the plurality of attributes associated with each of the identifier with each of the one or more users, a retrieving module to retrieve the one or more digital content from the first set of each of the one or more aerial vehicles pertaining to the digital entertainment systems associated with each of the identifier, a determination module to determine a plurality of credit points associated with each of the one or more users based on accessing of the one or more digital content and enable each of the one or more users to redeem the credit points when the pre-determined amount of the credit points associated with the at least one or more users exceeds the pre-defined threshold.

In an embodiment of the present of the present disclosure, the method and system include the plurality of attributes associated with the one or more digital content.

In another embodiment of the present of the present disclosure, the method and system include the plurality of attributes of one or more users.

In yet another embodiment of the present of the present disclosure, the identifier is the alphanumeric code.

In yet another embodiment of the present disclosure, the method and system include an enabling module to enable each of the one or more users to input the identifier.

In yet another aspect of the present disclosure, a computer system includes one or more processors and a non-transitory memory containing instructions that, when executed by the one or more processors, causes the one or more processors to perform a set of steps.

### BRIEF DESCRIPTION OF THE FIGURES

Having thus described the invention in general terms, reference will now be made to the accompanying drawings, which are not necessarily drawn to scale, and wherein:

FIG. 1 illustrates a system showing various components for in-flight handling of personalized entertainment data, in accordance with various embodiments of the present disclosure;

FIG. 2 illustrates a system showing interaction between communication devices and centralized server, in accordance with the embodiments of the present disclosure;

FIG. 3 is a flowchart illustrating a method for the in-flight handling of the personalized entertainment data, in accordance with the embodiment of the present disclosure;

FIG. 4 is a flowchart illustrating a method for the in-flight handling of the personalized entertainment data, in accordance with another embodiment of the present disclosure; and

FIG. 5 illustrates a block diagram of a dedicated computer that acts as the centralized server and/or localized servers, in accordance with various embodiments of the present disclosure

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

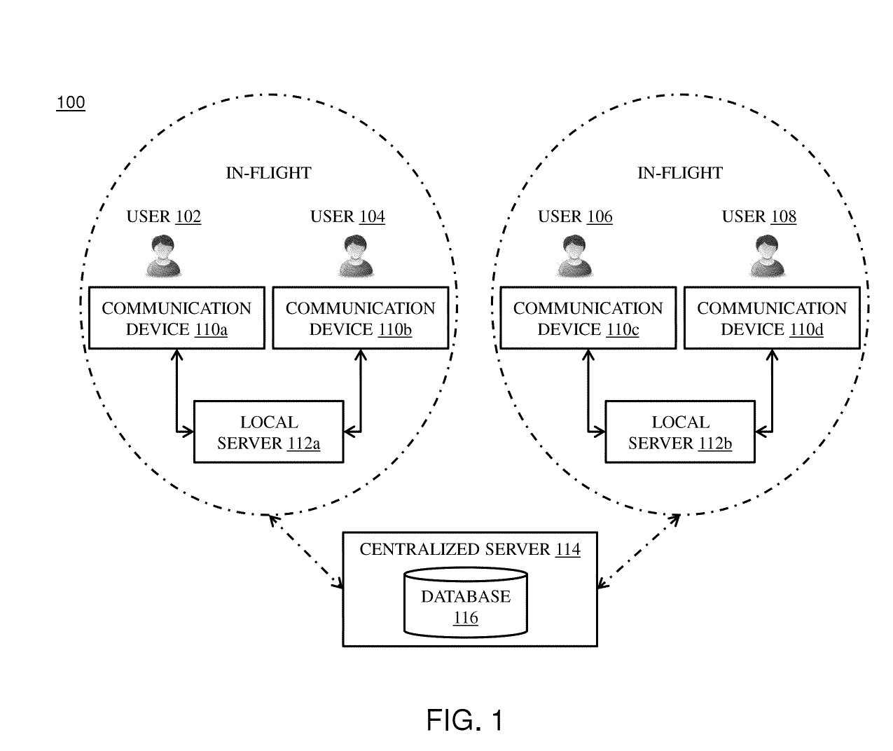

FIG. 1 illustrates a system 100 showing various components for in-flight handling of personalized entertainment data, in accordance with various embodiments of the present disclosure. The system 100 includes a user 102, a user 104, a user 106, a user 108, a communication device 110a, a communication device 110b, a communication device 110c, a communication device 110d, a local server 112a, a local server 112b, a centralized server 114 and a database 116. Examples of the users 102-108 include but may not be limited to passengers, in-flight staff and the like. Each of the users 102-108 is associated with the communication device 110a-d. The communication device 110a-d serves as in-flight entertainment (IFE) systems. Examples of the in-flight entertainment systems include but may not be limited to on-board mobile phones, digital gaming devices, personal televisions (hereinafter PTVs) and the like.

In an embodiment of the present disclosure, the communication devices 110a-b are connected with the local server 112a located at a first flight and the communication devices 110c-d are connected with the local server 112b located at a second flight.

Various mediums can be used for connectivity including internet, intranet and the like. The local server 112a-b is connected with the centralized server 114. The centralized server 114 includes the database 116. The local server 112a-b store personalized user information for each of the one or more users 102-108 including alphanumeric identifiers related to the users 102-108, the entertainment data utilized by the users 102-108 on the associated communication devices 110a-d and the like. The entertainment data includes but may not be limited to the in-flight movies, games, music playlists and the like. Moreover, the alphanumeric identifiers are unique codes, generated by at least one of the each of the one or more users 102-108, the local server 112a-b and the centralized server 114. Further, the alphanumeric identifiers can be used for various purposes including saving and transferring of the personalized user information of each of the one or more users 102-108 in the centralized server 114. Furthermore, saving and transferring of the personalized user information of each of the one or more users 102-108 enable each of the one or more users 102-108 to access the personalized user information from the centralized server 114 when any of the one or more users 102-108 moves from the first flight to the second flight or vice-versa. For example, a passenger X boards the first flight for a long distance journey involving two flights, thus requiring changing of the flight at an intermediate terminal. Moreover, the passenger X plays a game while travelling in the first flight. The passenger crosses various levels in the game and earns credits from the game. However, the terminal arrives and the passenger has to change the flight. Then, all the data related to the passenger X is saved in the local server 112a-b of the flight. The local server 112a-b transfers the data to the centralized server 114. The user 102-108 retrieves the data from the database 116 of the centralized server 114.

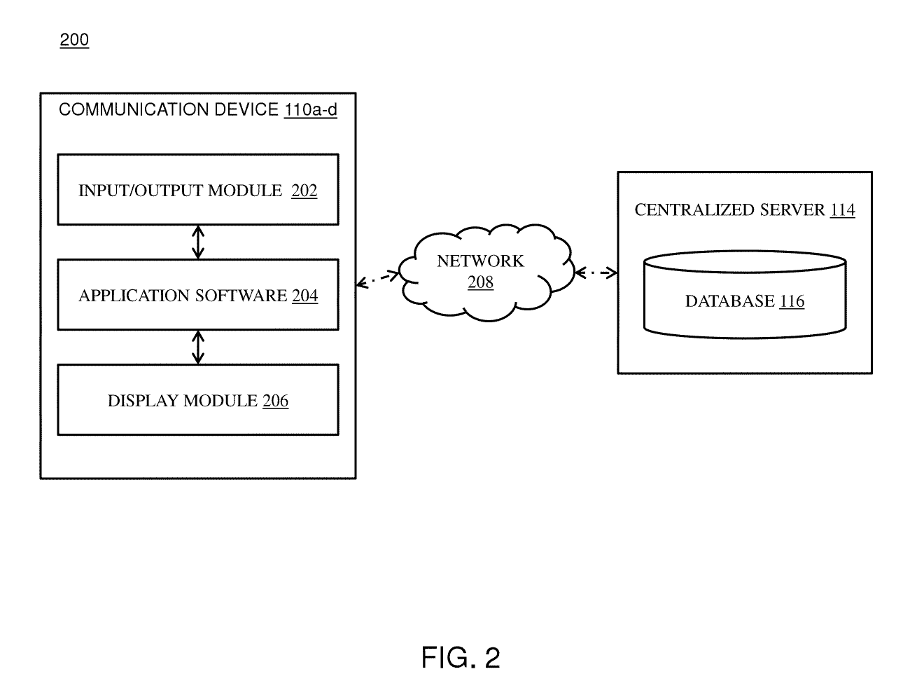

FIG. 2 illustrates a system 200 showing interaction between the communication devices 110a-d and the centralized server 114, in accordance with the embodiments of the present disclosure. The system 200 includes a block diagram of the communication devices 110a-d, a network 208 and a block diagram of the centralized server 114. The communication device 110a-d includes an input/output module 202, an application software 204 and a display module 206. Moreover, the centralized server 114 includes a database 116. The input/output module 202 collects the data related to the passengers (the users 102-108) associated with the communication device 110a-d and provides output to the passengers (the users 102-108). The application software 204 provides an interface to the user 102-108 to select type of the entertainment data to be displayed on the associated communication device 110a-d of the users 102-108. Examples of the entertainment data include but may not be limited to movies, games, songs, videos, presentations and the live-shows and the like. The display module 206 displays the selected type of the entertainment data on the communication device 110a-d associated with the user 102-108. For example, if the passenger X watches a movie for an hour, then the input/output module 202 in the communication device 110a-d associated with the passenger X receives the information of the users 102-108 including the alphanumeric identifier, name of the movie, status of the movie seen and the like and personalizes the information for the passenger X.

It may be noted that the application software 204 enables the users 102-108 to handle the personalized user information. Moreover, the application software 204 enables the users 102-108 to save the personalized user 102-108 information for later use. Further, the application software 204 enables the users 102-108 to resume access to the personalized entertainment data using the alphanumeric identifiers. Furthermore, the application software 204 enables the users 102-108 to utilize the credentials earned from the games for various purposes including shopping, mobile recharge, gift vouchers and the like. Furthermore, the application software 204 enables the users 102-108 to access and control the personalized user 102-108 information from the different communication devices (the communication device 110a-d)

In an embodiment of the present disclosure, the centralized server 114 may provide a catalogue stating various preferences/options for the in-flight entertainment data and related in-flight activities. The catalogue may be provided online by each of the local servers 112a and 112b on the communication devices 110a-d of the users 102-108. Moreover, the centralized server 114 enables each of the users 102-108 to access and customize the preferences/options for the entertainment data and in-flight activities using the corresponding alphanumeric identifiers. Further, the centralized server 114 enables the users 102-108 to access and customize the entertainment data and the in-flight activities (personalized digital content) inside as well as outside the flight. Thus, the users 102-198 can have greater control over the personalized digital content corresponding to the alphanumeric identifiers. Furthermore, the in-flight entertainment systems may be standardized by airlines by providing different in-flight entertainment systems for different airlines, For example, different airlines may use different centralized server. Furthermore, the in-flight entertainment may be provided to the users 102-108 through an online airline website. The users 102-108 may access the in-flight entertainment data by logging on the online airline website using the corresponding identifiers. The airline website may provide online catalogue to the user 102-108 to enable the users 102-108 to access and personalize the in-flight entertainment data. In addition, each of the users 102-108 may view the status of the personalized digital content by signing in to their specific homepages using their corresponding identifiers.

In an example, the centralized server 114 allows passengers travelling in an aircraft/airline with In-Flight Entertainment Systems (IFEs) to transfer their entertainment data from one flight to another using assistance of a code or other alphanumeric identifier. Thus, the centralized server 114 enables the passengers to have greater control and convenience regarding entertainment-experience on the flight. For example, the passengers may view half of a movie in a flight and then resume the movie at the specified position on their next connecting flight. The next connecting flight accesses the data of the passengers from the centralized server 114. The data may include gaming high scores, music playlists and the like. Thus, the application server 112 provides a way to standardize the entertainment and facilitate the personalization of a passenger's utilization of a PTV (personal TV). In addition, the application server 112 allows the passenger to save and transfer his/her entertainment preferences, data, and other items. In addition, the centralized server 114 provides an alphanumerical code to each passenger for a flight. The code provides access to the saved data of the passenger and is assigned according to the convenience of the airline or the passenger. The user enters the given identifier/alphanumerical code to a PTV to load his/her saved data. The identifier/alphanumerical code may be indicated upon an E-Ticket, account, boarding passes and the like. Further, the local server 112a-b and the centralized server 114 correspond with each other when possible to enable the transfer of data between the flights and to allow the passengers to use each flight's IFE to resume the data from where they left off The information stored in the local server 112a-b and the centralized server 114 may be synced for each passenger on the flight.

In another embodiment of the present disclosure, the plurality of attributes is associated with one or more digital content.

In yet another embodiment of the present disclosure, the plurality of attributes is the plurality of attributes of one or more users 102-108.

In yet another embodiment of the present disclosure, the identifier is an alphanumeric code.

In yet another embodiment of the present disclosure, the system 200 enables each of the one or more users 102-108 to input the identifier.

In yet another embodiment of the present disclosure, the system 200 provides credit points associated with accessing the plurality of digital content.

In yet another embodiment of the present disclosure, the system 200 enables each of the one or more users 102-108 to redeem the credit points when a pre-determined amount of the credit points associated with at least one or more users 102-108 exceeds a pre-defined point.

In yet another embodiment of the present disclosure, the centralized server 114 may be located at a ground station or in some flight/aircraft. Moreover, the centralized server 114 enables the functioning of the application software 204. Furthermore, the centralized server 114 enables controlling the personalized user information from a single site.

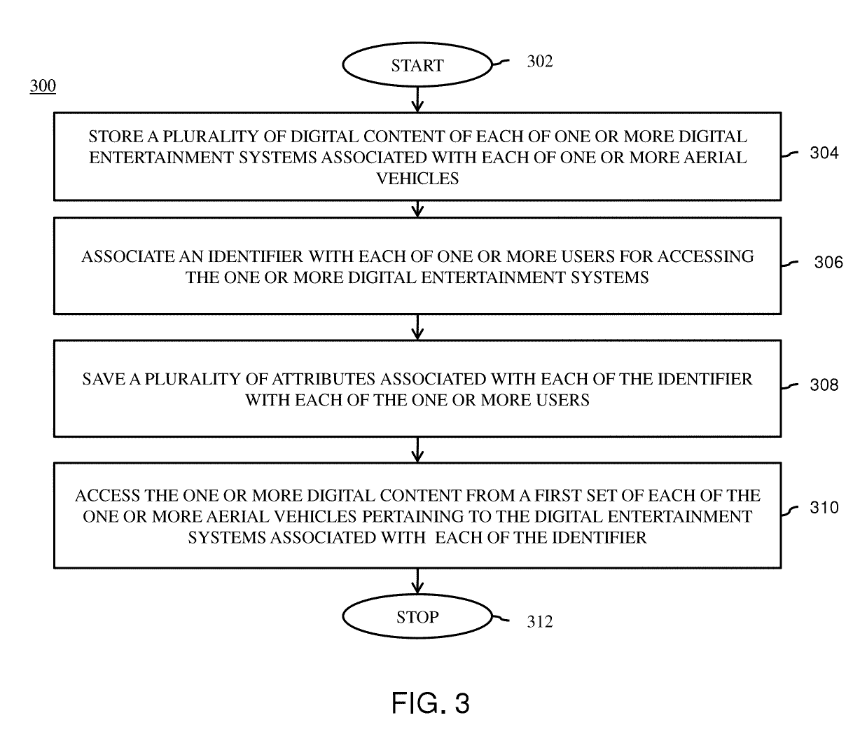

FIG. 3 is a flowchart 300 illustrating a method for the in-flight handling of the personalized entertainment data, in accordance with the various embodiments of the present disclosure. The flowchart initiates at step 302. Following step 302, at step 304, the centralized server 114 stores the plurality of digital content of each of one or more digital entertainment systems associated with each of one or more aerial vehicles. Following step 304, at step 306, the centralized server 114 associates an identifier with each of the one or more users 102-108 for accessing the one or more digital entertainment systems. Following step 306, at step 308, the centralized server 114 saves a plurality of attributes associated with each of the identifier with each of the one or more users 102-108. Following step 308, at step 310, the centralized server 114 accesses the one or more digital content from a first set of each of the one or more aerial vehicles pertaining to the digital entertainment systems associated with each of the identifier. The flowchart terminates at step 312.

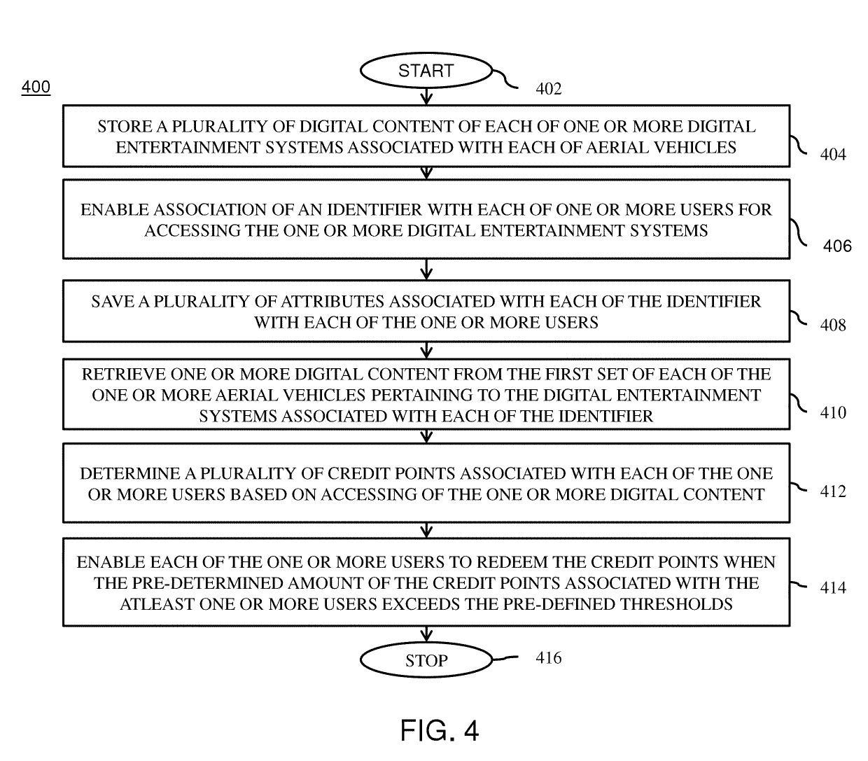

FIG. 4 is a flowchart 400 illustrating a method for the in-flight handling of the personalized entertainment data, in accordance with the various embodiments of the present disclosure. The flowchart initiates at step 402. Following step 402, at step 404, the centralized server 114 stores the plurality of digital content of each of the one or more digital entertainment systems associated with each of the one or more aerial vehicles. Following step 404, at step 406, the centralized server 114 enables association of the identifier with each of the one or more users 102-108 for accessing the one or more digital entertainment systems. Following step 406, at step 408, the centralized server 114 saves the plurality of attributes associated with each of the identifier with each of the one or more users 102-108. Following step 408, at step 410, the centralized server 114 retrieves the one or more digital content from the first set of each of the one or more aerial vehicles pertaining to the digital entertainment systems associated with each of the identifier. Following step 410, at step 412, the centralized server 114 determines a plurality of credit points associated with each of the one or more users 102-108 based on accessing of the one or more digital content. Following step 412, at step 414, the centralized server 114 enables each of the one or more users 102-108 to redeem the credit points when the pre-determined amount of the credit points associated with the at-least one or more users 102-108 exceeds the pre-defined threshold. The flowchart terminates at step 416.

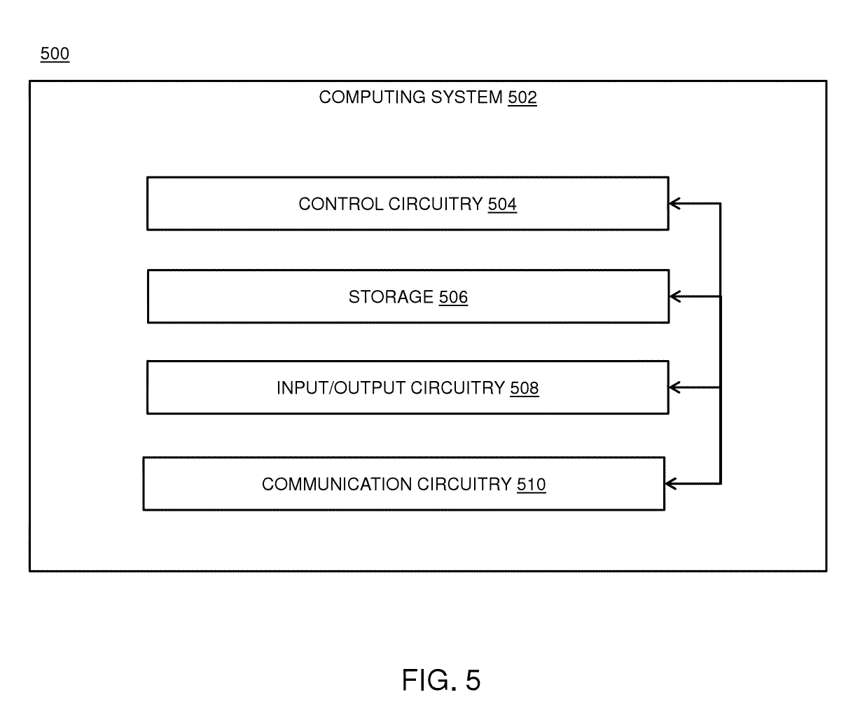

FIG. 5 illustrates a block diagram 500 of a dedicated computer 502 that acts as the centralized server 114 and/or localized servers 112a, 112b, in accordance with various embodiments of the present disclosure. It may be noted that to explain the block diagram 500 of the dedicated computer 502 that acts as the server 106, references will be made to the various elements of the system 100.

The dedicated computer 502 includes but may not be limited to a control circuitry 504, storage 506, an input/output circuitry 508, and a communication circuitry 510.

From the perspective of this disclosure, the control circuitry 504 includes any processing circuitry or processor operative to control the operations and performance of the dedicated computer 502. For example, the control circuitry 504 may be used to run operating system applications, firmware applications, media playback applications, media editing applications, or any other application. In an embodiment, the control circuitry 504 drives a display and process inputs received from a user interface.

From the perspective of this disclosure, the storage 506 includes one or more storage mediums including a hard-drive, solid state drive, flash memory, permanent memory such as ROM, any other suitable type of storage component, or any combination thereof. The Storage 506 may store, for example, media data (e.g., music and video files), application data (e.g., for implementing functions on the dedicated computer 502).

From the perspective of this disclosure, the I/O circuitry 508 may be operative to convert (and encode/decode, if necessary) analog signals and other signals into digital data. In an embodiment, the I/O circuitry 508 may also convert digital data into any other type of signal, and vice-versa. For example, the I/O circuitry 508 may receive and convert physical contact inputs (e.g., from a multi-touch screen), physical movements (e.g., from a mouse or sensor), analog audio signals (e.g., from a microphone), or any other input. The digital data may be provided to and received from the control circuitry 504, the storage 506, or any other component of the dedicated computer 502.

It may be noted that the I/O circuitry 508 is illustrated in FIG. 3 as a single component of the dedicated computer 502; however those skilled in the art would appreciate that several instances of the I/O circuitry 508 may be included in the dedicated computer 502.

The dedicated computer 502 may include any suitable interface or component for allowing a user to provide inputs to the I/O circuitry 508. The dedicated computer 502 may include any suitable input mechanism. Examples of the input mechanism include but may not be limited to a button, keypad, dial, a click wheel, and a touch screen. In an embodiment of the present disclosure, the dedicated computer 502 may include a capacitive sensing mechanism, or a multi-touch capacitive sensing mechanism.

In an embodiment, the dedicated computer 502 may include specialized output circuitry associated with output devices such as, for example, one or more audio outputs. The audio output may include one or more speakers built into the dedicated computer 502, or an audio component that may be remotely coupled to the dedicated computer 502.

The one or more speakers can be mono speakers, stereo speakers, or a combination of both. The audio component can be a headset, headphones or ear buds that may be coupled to communications device with a wire or wirelessly.

In an embodiment, the I/O circuitry 508 may include display circuitry for providing a display visible to the user. For example, the display circuitry may include a screen (e.g., an LCD screen) that is incorporated in the dedicated computer 502.

The display circuitry may include a movable display or a projecting system for providing a display of content on a surface remote from the dedicated computer 502 (e.g., a video projector). In an embodiment, the display circuitry may include a coder/decoder to convert digital media data into analog signals. For example, the display circuitry may include video Codecs, audio Codecs, or any other suitable type of Codec.

The display circuitry may include display driver circuitry, circuitry for driving display drivers, or both. The display circuitry may be operative to display content. The display content can include media playback information, application screens for applications implemented on the electronic device, information regarding ongoing communications operations, information regarding incoming communications requests, or device operation screens under the direction of the control circuitry 504. Alternatively, the display circuitry may be operative to provide instructions to a remote display.

From the prospective of this disclosure, the communications circuitry 510 may include any suitable communications circuitry operative to connect to a communications network and to transmit communications (e.g., voice or data) from the dedicated computer 502 to other devices within the communications network. The communications circuitry 510 may be operative to interface with the communications network using any suitable communications protocol. Examples of the communications protocol include but may not be limited to Wi-Fi, Bluetooth, RTM, radio frequency systems, infrared, LTE, GSM, GSM plus EDGE, CDMA, and quadband.

In an embodiment of the present disclosure, the same instance of the communications circuitry 510 may be operative to provide for communications over several communications networks. In an embodiment of the present disclosure, the dedicated computer 502 may be coupled a host device for data transfers, synching the communications device, software or firmware updates, providing performance information to a remote source (e.g., providing riding characteristics to a remote server) or performing any other suitable operation that may require the dedicated computer 502 to be coupled to a host device. Several computing devices may be coupled to a single host device using the host device as a server. Alternatively or additionally, the dedicated computer 502 may be coupled to several host devices (e.g., for each of the plurality of the host devices to serve as a backup for data stored in the dedicated computer 502).

In an aspect of the present disclosure, the method and system enable passengers to have greater control and convenience regarding the entertainment experienced on the flight. For example, the passengers may now end the flight halfway through a movie and then resume the movie at the specified position on connecting flight, having the data from the prior flight saved upon it. Moreover, the method and system offer promotions where the passengers can earn credits based on events including scoring points in the in-flight video games.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A method for enabling sharing of digital content in one or more aerial vehicles, the method comprising:
storing a plurality of digital content of each of one or more digital entertainment systems associated with each of one or more aerial vehicles;
associating an identifier with each of one or more users for accessing the one or more digital entertainment systems;
saving a plurality of attributes associated with each of the identifier with each of the one or more users; and
accessing the one or more digital content from a first set of each of the one or more aerial vehicles pertaining to the digital entertainment systems associated with each of the identifier.

2. The method as recited in claim 1, wherein the plurality of attributes is the plurality of attributes associated with the one or more digital content.

3. The method as recited in claim 1, wherein the plurality of attributes is the plurality of attributes of the one or more users.

4. The method as recited in claim 1, wherein the identifier is an alphanumeric code.

5. The method as recited in claim 1, further comprising enabling each of the one or more users to input the identifier.

6. The method as recited in claim 1, further comprising providing credit points associated with accessing the plurality of digital content.

7. The method as recited in claim 1, further comprising enabling each of the one or more users to redeem the credit points when a pre-determined amount of the credit points associated with the at least one or more users exceeds a pre-defined point.

8. A method for enabling sharing of the digital content in the one or more aerial vehicles, the method comprising:
storing a plurality of digital content of each of the one or more digital entertainment systems associated with each of the one or more aerial vehicles;
enabling association of the identifier with each of the one or more users for accessing the one or more digital entertainment systems;
saving a plurality of attributes associated with each of the identifier with each of the one or more users;
retrieving the one or more digital content from the first set of each of the one or more aerial vehicles pertaining to the digital entertainment systems associated with each of the identifier;
determining a plurality of the credit points associated with each of the one or more users based on accessing of the one or more digital content; and
enabling each of the one or more users to redeem the credit points when the pre-determined amount of the credit points associated with the at least one or more users exceeds the pre-defined threshold.

9. The method as recited in claim 8, wherein the plurality of attributes is the plurality of attributes associated with the one or more digital content.

10. The method as recited in claim 8, wherein the plurality of attributes is the plurality of attributes of the one or more users.

11. The method as recited in claim 8, wherein the identifier is the alphanumeric code.

12. The method as recited in claim 8, further comprising enabling each of the one or more users to input the identifier.

13. A computer system comprising:
one or more processors; and
a non-transitory memory containing instructions that, when executed by said one or more processors, causes said one or more processors to perform a set of steps comprising:
storing a plurality of digital content of each of the one or more digital entertainment systems associated with each of the one or more aerial vehicles;
enabling association of the identifier with each of the one or more users for accessing the one or more digital entertainment systems;
saving a plurality of attributes associated with each of the identifier with each of the one or more users; and
retrieving one or more digital content from the first set of each of the one or more aerial vehicles pertaining to the digital entertainment systems associated with each of the identifier;

14. The computer system as recited in claim 13, wherein the plurality of attributes is the plurality of attributes associated with the one or more digital content.

15. The computer system as recited in claim 13, wherein the plurality of attributes is the plurality of attributes of the one or more users.

16. The computer system as recited in claim 13, wherein the identifier is the alphanumeric code.

17. The computer system as recited in claim 13, wherein said non-transitory memory containing instructions that, when executed by said one or more processors, cause said one or more processors to perform a further step of further comprising enabling each of the one or more users to input the identifier.

18. The computer system as recited in claim 13, wherein said non-transitory memory containing instructions that, when executed by said one or more processors, cause
